(19) United States
(12) Patent Application Publication
(10) Pub. No.: US 2003/0067379 A1
(43) Pub. Date: Apr. 10, 2003

(54) Biometric in-flight aircraft flight crew authentication system

(76) Inventor: Jonathan C. Riley, North Kingstown, RI (US)

Correspondence Address: Cari & Offenberg, 494 Broadway, Newport, RI, 02840, US

(21) Appl. No.: 10/266,214

(22) Filed: Oct. 8, 2002

Related U.S. Application Data
(60) Provisional application No. 60/327,939, filed on Oct. 9, 2001.

(51) Int. Cl. H04Q 1/00; G05B 19/00

(52) U.S. Cl. 340/5.53

(57) ABSTRACT

A biometric in-flight aircraft flight crew authentication system for providing repetitive in-flight authentication of the identity of the individual or individuals at the controls of an aircraft, and, providing communication of failure to authenticate to an appropriate party or parties inside and/or outside of the aircraft allowing them to take in-flight corrective action as necessary The invention also optionally provides communication to an onboard preprogrammed autopilot system (if available) allowing it to disable manual controls and initiate a safe flight pattern until the identity of those at the controls can be authenticated.

### RELATED APPLICATIONS

This application relates back to provisional application filed on Oct. 9, 2001 application No. 60/327,939.

### BACKGROUND OF THE INVENTION

1. Field of the Invention

The present invention relates generally to biometric security devices and more specifically it relates to a biometric in-flight aircraft flight crew authentication system providing repetitive in-flight authentication for the identity of the individual or individuals at the controls of an aircraft, and, further providing communication of failure to authenticate to an appropriate party or parties inside or outside of the aircraft allowing them to take in-flight corrective action as necessary The invention also provides for communication to an onboard preprogrammed autopilot system (if available) allowing it to disable manual controls and initiate a safe flight pattern until the identity of those at the controls can be authenticated.

2. Description of the Prior Art

It can be appreciated that biometric security devices have been in use for years Typically, biometric security devices are comprised of security systems that confirm clearance to enter a restricted area or allow operation of a device by comparing a biometric input such as a fingerprint read on a local biometric scanning device to the information contained on a smart card carried by the individual wishing to gain access to the restricted area or operate the device, or to information stored on a computer, or microprocessor control attached to the biometric scanning device

The main problem with conventional biometric security devices is that their only potential function is to prevent initial access to a restricted area, or initial operation of a device Should they be bypassed by either fraudulent or forceful means, and any unauthorized access is gained to the restricted area or an operating device, (for example into the cockpit of an aircraft), no further security is provided In the case of an aircraft, they do not repetitively authenticate who is at the controls of the aircraft through active biometric confirmation of the identity of the individual or individuals attempting to operate the primary flight controls Furthermore, they in no way prevent unauthorized personnel from taking control of the aircraft once they have gained access to the cockpit.

Another problem with conventional biometric security devices is that they do not provide for communication with appropriate parties outside or inside of the aircraft should there be a breach of security They merely serve as biometric locks and do not contain any communication capability to notify the FAA or similar controlling body outside of the aircraft, or crew members in other areas inside of the aircraft, of a potentially dangerous situation resulting from unauthorized personnel at the controls.

Another problem with conventional biometric security devices is that, should an unauthorized person or persons gain access to the flight controls, they do not provide any mechanism for preventing an unauthorized individual from flying the aircraft in an unsafe manner, thereby causing significant harm to the aircraft and its occupants, other aircraft and their occupants, and/or ground structures and their occupants Not only do they not prevent the unauthorized individual from flying the aircraft in an unsafe manner, they do not contain any provision for instructing the aircraft to fly in a safe manner by communicating with the aircraft's autopilot system causing it to initiate a preprogrammed flight pattern, and rendering the primary manual flight controls inoperable.

Some examples of biometric security devises include U.S. Pat. No. 5,686,765 that has a repetitive biometric system, however, it is designed for only a specific time period and it disables the vehicle if it fails to authenticate, which would be catastrophic in an aircraft U.S. Pat. No. 5,715,905 has a biometric system but it is not repetitive and merely disables the starter, which does not allow unauthorized individuals to start the vehicle. It does not provide any further security once the vehicle is in operation U.S. Pat. No. 6,225,890 is biometric and repetitive but also disables the vehicle during use if it fails to authenticate, which would be catastrophic for an aircraft

While the prior art devices may be suitable for the particular purpose to which they address, they are not suitable for providing repetitive authentication of the identity of the individual, or individuals, at the controls of an aircraft before or during flight, and, providing communication of failure to authenticate to an appropriate party or parties inside and/or outside of the aircraft allowing them to take in-flight corrective action as necessary

None of the known prior art devices have the novel features of this invention or are specifically adaptable to aircraft use As an aircraft would crash if disabled, the repetitive authentication system needs a control function that allows the aircraft to keep flying Most of the prior art references disable the starter, or disable the vehicle while it is in use Also the security system in an airplane must be always on so it can continue to repetitively check the authentication and communicate failure to authenticate Most of the prior art systems lack a communication system, are not repetitive and need to be turned on or activated Many prior art devices have a single input authentication frequency. The repetitive function is also necessary as an aircraft passenger can enter the cockpit after the initial identity of the crew has been authenticated

There are no prior art references that combine the novel features of this invention, namely, an authentication system that requires authorized use, is biometric, repetitive frequency, portable identification, inside and outside vehicle communication, does not disable vehicle, is continuously “on”, and capable of being used in an aircraft.

In these respects, the biometric in-flight aircraft flight crew authentication system according to the present invention substantially departs from the conventional technology, concepts, and designs of the prior art, and in so doing, the present invention provides an apparatus primarily developed for the purpose of providing before and during flight authentication of the identity of the individual or individuals at the controls of an aircraft, and, providing communication of failure to authenticate to an appropriate party or parties inside or outside of the aircraft allowing them to take in-flight corrective action as necessary The invention also provides for communication to an onboard preprogrammed autopilot system (if available on the specific aircraft) allowing it to disable manual controls and to initiate a safe flight pattern until the identity of those at the controls can be authenticated

### SUMMARY OF THE INVENTION

In view of the foregoing disadvantages inherent in the known types of biometric security devices now present in the prior art, the present invention provides a new biometric in-flight aircraft flight crew authentication system wherein the same can be utilized for providing repetitive before and during flight authentication of the identity of the individual or individuals at the controls of an aircraft, and, for providing communication of failure to authenticate to an appropriate party or parties inside and/or outside of the aircraft allowing them to take in-flight corrective action as necessary The invention also provides for communication to an onboard preprogrammed autopilot system (if available) allowing it to disable manual controls and initiate a safe flight pattern until the identity of those at the controls can be authenticated

The general purpose of the present invention, which will be described subsequently in greater detail, is to provide a new biometric in-flight aircraft flight crew authentication system that has many of the advantages of the biometric security devices mentioned heretofore and many novel features that result in a new biometric in-flight aircraft flight crew authentication system which is not anticipated, rendered obvious, suggested, or even implied by any of the prior art biometric security devices, either alone or in any combination thereof.

The present invention generally comprises a fingerprint scanning device, or devices, mounted on the primary aircraft controls, or any other suitable location on the flight deck or “cockpit” A number of smart card readers at least equal to the number of fingerprint scanning devices, a communications module, and a microprocessor control module that controls all of the aforementioned components The fingerprint scanning device is a device which captures an image of an individual's fingerprint and relays that image to the microprocessor control module The smart card reader is a card reader designed to accept a smart card and to read the information contained thereon The communications module is a communications device that is able to accept and transmit signals via a hardwired or wireless medium and is intended to be a smart device The microprocessor control module is a small footprint computer/micro-microprocessor control module that controls the fingerprint scanning device(s), smart card reader(s), and communications module utilized in this invention.

There has thus been outlined, rather broadly, the more important features of the invention in order that the detailed description thereof may be better understood, and in order that the present contribution to the art may be better appreciated. There are additional features of the invention that will be described hereinafter

In this respect, before explaining at least one embodiment of the invention in detail, it is to be understood that the invention is not limited in its application to the details of construction and to the arrangements of the components set forth in the following description or illustrated in the drawings The invention is capable of other embodiments and of being practiced and carried out in various ways Also, it is to be understood that the phraseology and terminology employed herein are for the purpose of the description and should not be regarded as limiting

A primary object of the present invention is to provide a biometric in-flight aircraft flight crew authentication system that will overcome the shortcomings of the prior art devices

An object of the present invention is to provide a biometric in-flight aircraft flight crew authentication system for providing repetitive in-flight authentication of the identity of the individual or individuals at the controls of an aircraft at regular intervals during flight.

Another object is to provide a biometric in-flight aircraft flight crew authentication system that, in the event that identity cannot not be authenticated, initiates a predetermined sequence of actions intended to ensure the safety of the aircraft in question and its occupants, other aircraft and their occupants, and objects or structures on the ground and their occupants

Another object is to provide a biometric in-flight aircraft flight crew authentication system that upon failing to detect and authenticate the identity of the person at the controls of the aircraft, communicates with an appropriate party or parties outside and/or inside of the aircraft and notifies them of an unauthenticated individual at the controls.

Another object is to provide a biometric in-flight aircraft flight crew authentication system that upon failure to authenticate identity, sends a signal to the aircraft's autopilot system (where available and suitably programmed) instructing the autopilot system to initiate a preprogrammed safe flight pattern and to disable the manual flight controls The invention is only intended to notify the onboard autopilot system of the breach of security, and the need to execute a predetermined flight program resident in the autopilot system

Another object is to provide a biometric in-flight aircraft flight crew authentication system that upon subsequent identity authentication sends another signal to the autopilot system to return control of the aircraft to the manual controls.

Other objects and advantages of the present invention will become obvious to the reader and it is intended that these objects and advantages are within the scope of the present invention

To the accomplishment of the above and related objects, this invention may be embodied in the form illustrated in the accompanying drawings, attention being called to the fact, however, that the drawings are illustrative only, and that changes may be made in the specific construction illustrated

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein.

FIG. 1 is a schematic of an aircraft control yoke mounted system.

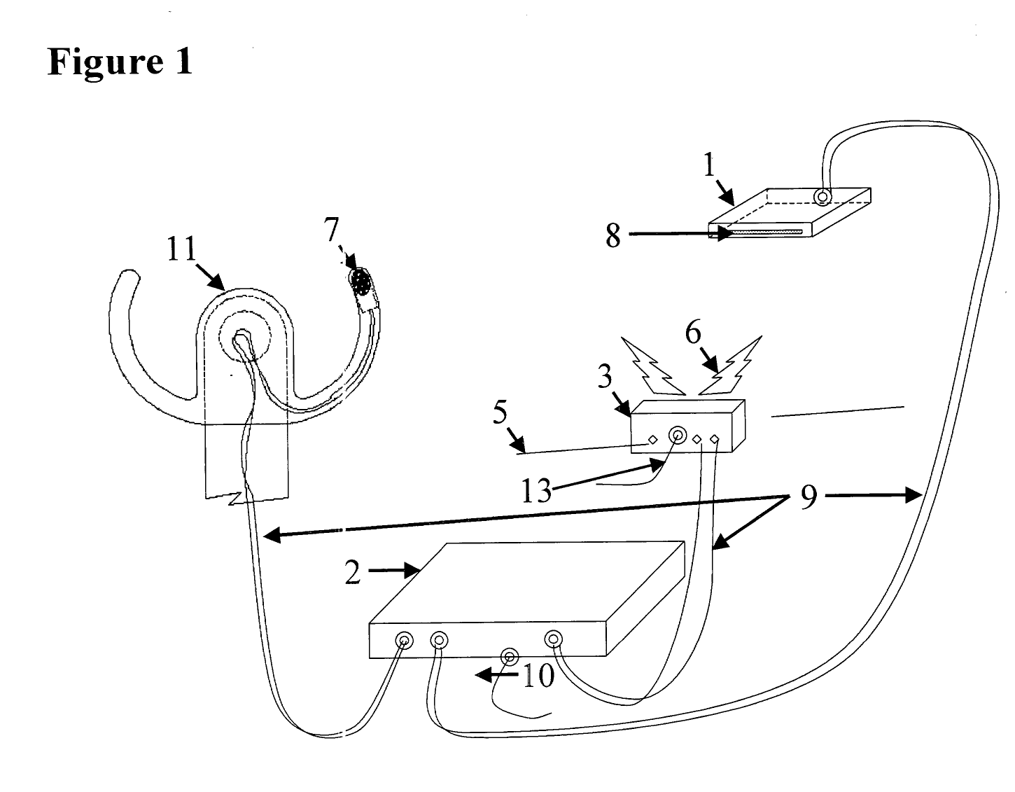

FIG. 2 is a schematic of an aircraft control stick mounted system.

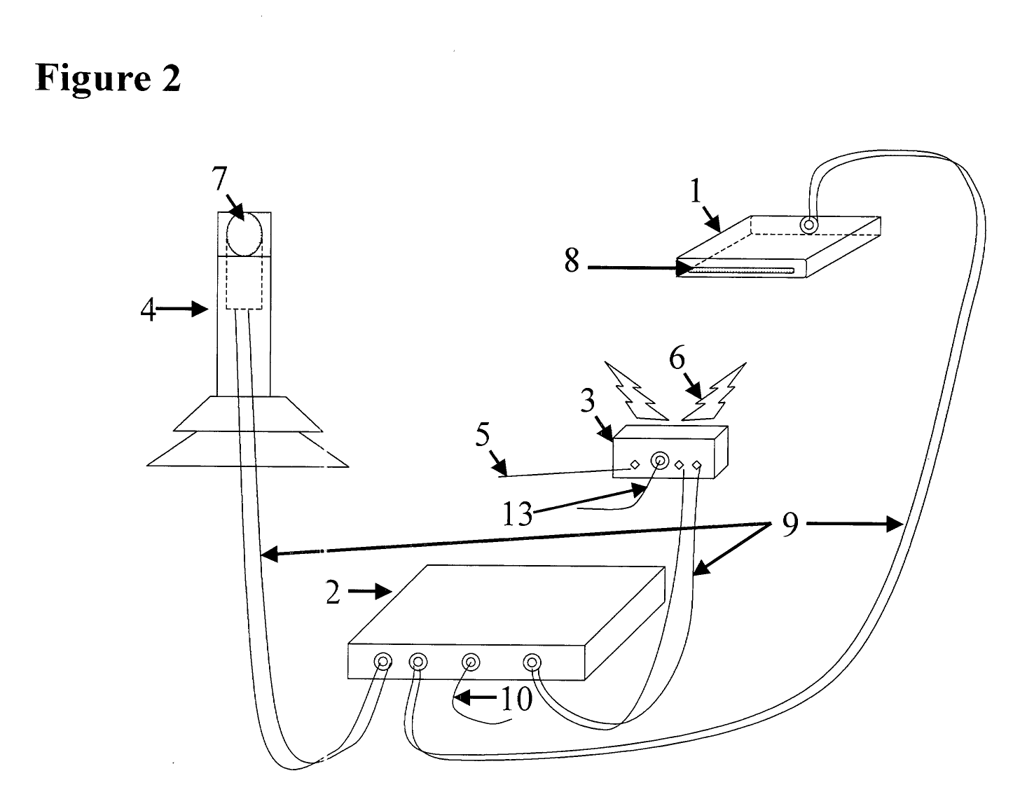

FIG. 3 is a schematic of a flight deck mounted system.

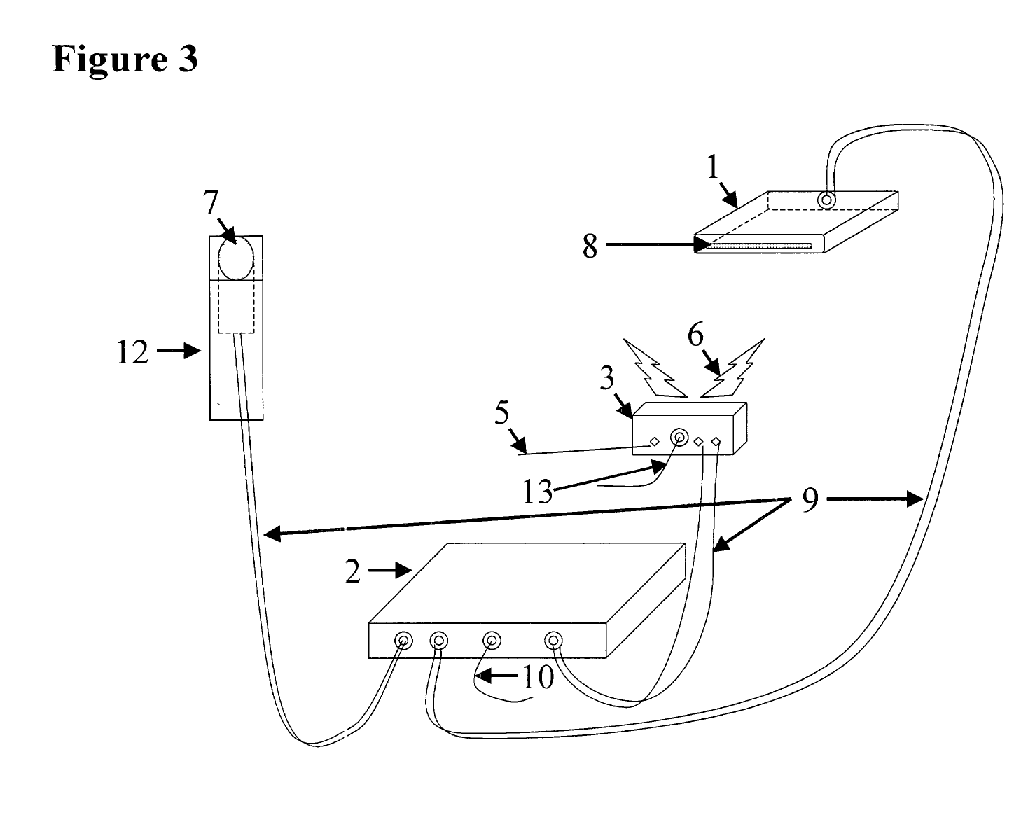

FIG.4 is a plan and side view of the fingerprint scanning device mounted on an aircraft control yoke

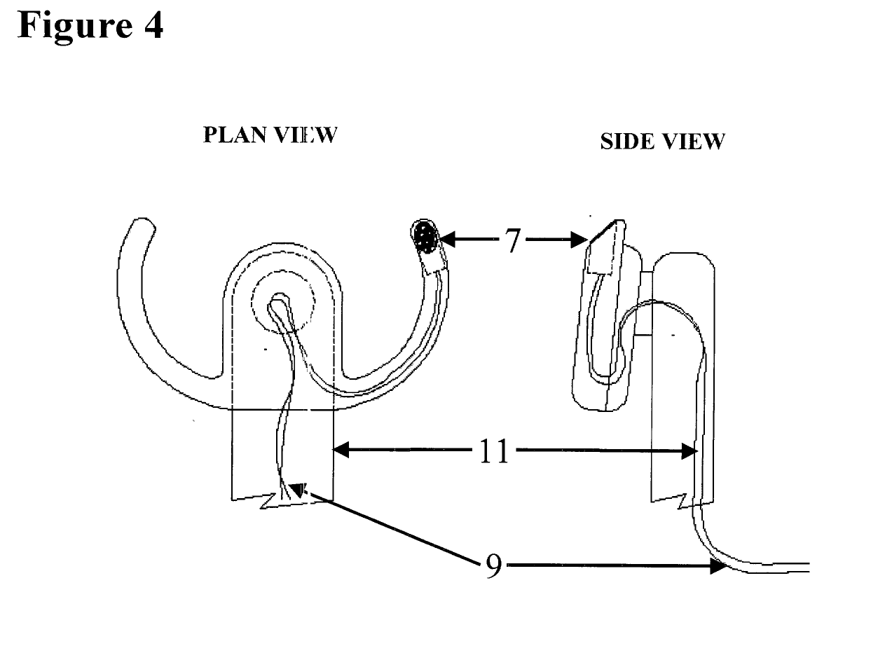

FIG. 5 is a plan view and side view of the fingerprint scanning device mounted on an aircraft control stick

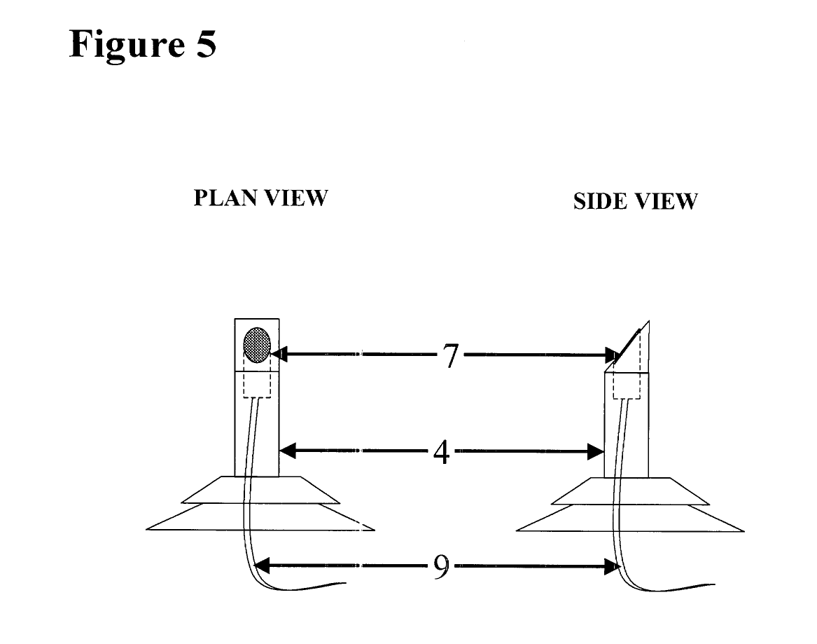

FIG. 6 is a plan view and side view of the free standing scanner mounted on an aircraft flight deck

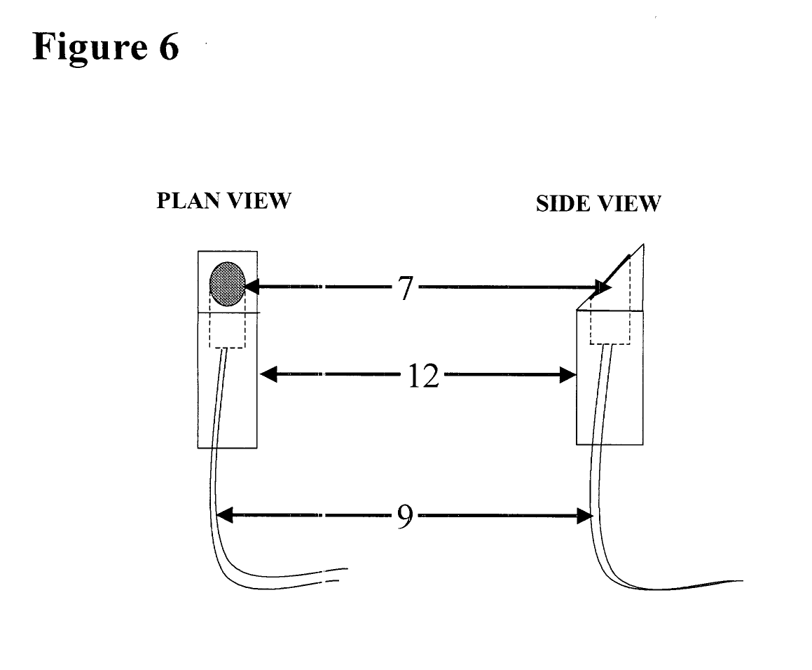

FIG. 7 is plan view of the alternate mounting locations for the fingerprint scanning device on a control yoke.

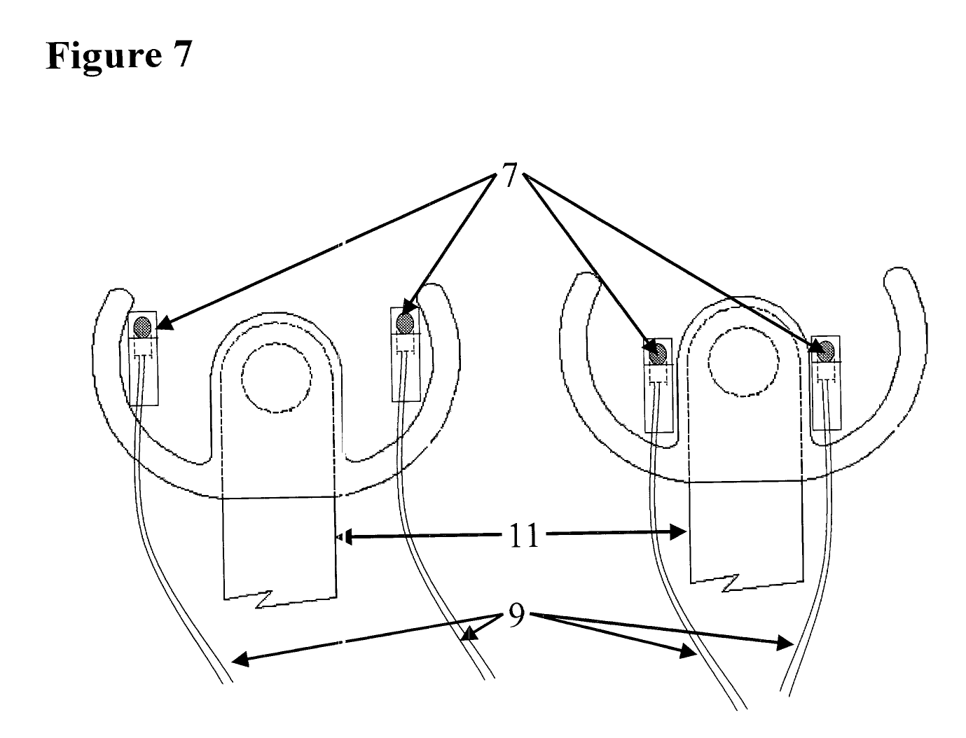

FIG. 8 is a plan view of the alternate mounting locations for the fingerprint scanning device on the control stick.

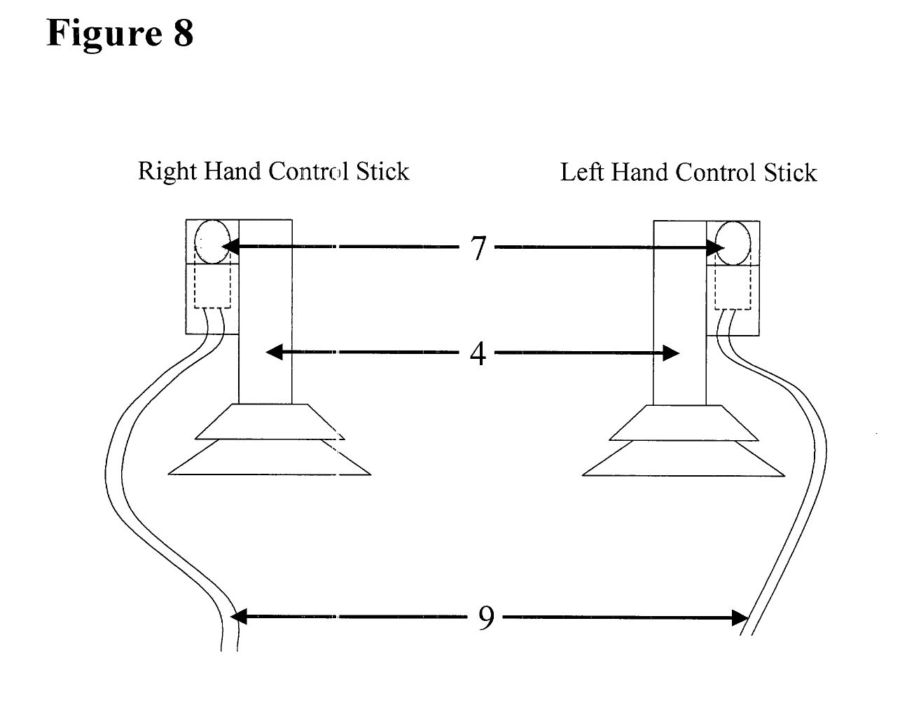

FIG. 9 is a plan view of a left and right hand yoke mounted fingerprint scanning device

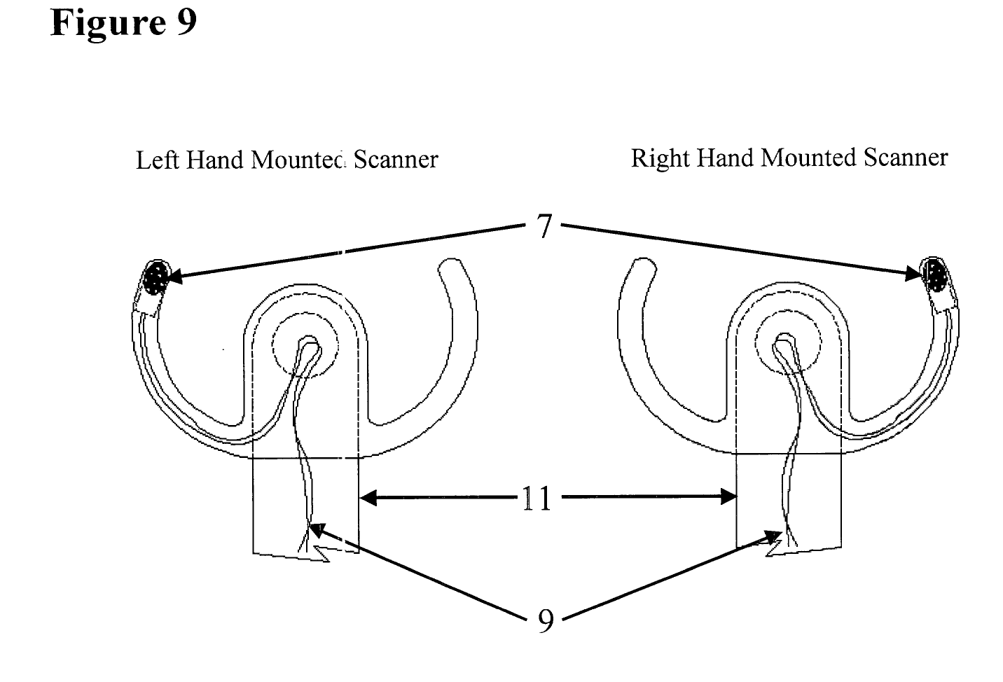

FIG. 10 is a flowchart of the operation of the invention.

### DESCRIPTION OF THE PREFERRED EMBODIMENT

Turning now descriptively to the drawings, in which similar reference characters denote similar elements throughout the several views, the attached figures illustrate a biometric in-flight aircraft flight crew authentication system, which comprises a scanning means such as fingerprint scanning device (7), or devices, mounted on the primary aircraft controls, or any other suitable location on the flight deck (cockpit). A number of memory reading means such as smart card readers (1), at least equal to the number of fingerprint scanning devices (7) A communications module (3), and a microprocessor control module (2) that controls all of the aforementioned components. The fingerprint scanning device (7) is a device which captures a line image of an individual's fingerprint on board and relays that image to the microprocessor control module (2). The smart card reader (1) is a card reader designed to accept a stored memory means such as smart card and to read the information contained thereon. The communications module (3) is a communications means that is able to accept and transmit signals via a hardwired or wireless medium and is intended to be a smart device. The microprocessor control module (2) is a small footprint computer or micro-microprocessor control module that controls the fingerprint scanning device (7), smart card readers (1), and communications module (3) utilized in this invention.

The fingerprint scanning device (7) is a device which captures an image of an individual's fingerprint and transmits that image to the microprocessor control module (2) Typically these devices function through the internal emission of a pattern of light that is reflected by the fingerprint held against the scanning surface The reflected image is captured via a small integral camera and provided to the microprocessor control module (2) for analysis The physical construction is in the form of a self contained scanning unit, separate from the microprocessor control module (2) and smart card reader (1). Care should be taken in the installation of the fingerprint scanning device (7) via a hardwire connection (9), that the wiring is protected from potential physical wear resulting from the typical operation of the controls. The fingerprint scanning device (7) can also be integrated into the microprocessor control module (2), and even be contained in a “module” that contains both the microprocessor control module (2) and the smart card reader (1) There are various physical constructions of the fingerprint scanning device (7) available The physical design is not limited to the physical construction described in the attached Figures, but may also include another physical design as preferred by the user for ease of use, reliability, and placement on the aircraft. Another potential variation of the fingerprint scanning device (7) would be the use of a scanner that has live finger detection capabilities, adding a further measure of security.

The smart card reader (1) is a card reader designed to accept a smart card and to read the information contained thereon The smart card reader (1) does not store the information contained on the smart card but merely reads the information and provides it to the microprocessor control module (2). The smart card reader (1) is connected to the microprocessor control module (2) via a hardwire connection (9). The smart card reader (1) can also be integrated into the microprocessor control module (2), and may even be contained in a “module” that contains both the microprocessor control module (2) and the fingerprint scanning device (7) The hardwired connection (9) may be replaced by a suitable wireless connection

The communications module (3) is a communications device that is able to accept and transmit signals via a hardwired or wireless medium and is intended to be a programmable device It receives and transmits signals via a hardwired or wireless such as RS232; or a similar interface It is capable of receiving a signal or signals from the aircraft's onboard transponder and/or communications system as well as the microprocessor control module (2) It contains an integral or closely connected programmable microprocessor which can be programmed to send predetermined signals, and/or messages, upon receiving a signal from the microprocessor control module (2). The predetermined signals, and or messages, may be sent to parties outside of the aircraft such as air traffic control tower, as well as, to onboard systems, such as the autopilot system or audible and/or visual alarms in the crew areas of the passenger compartment via wireless means This communication may be accomplished via a radio frequency or other suitable signal Alternatively, in the case of communication with onboard systems, the signal may be sent via hardwired communications (5). The power supply to the communications module (3) may be interlocked with an appropriate onboard system thereby only allowing it to function when the aircraft is in motion. This would be accomplished through a suitably designed hardwired power connection (13). Care should be taken in the installation of the communications module (3) via a hardwire connection (9), that the wiring is protected from potential physical wear resulting from the typical operation of the controls The communications module (3) may be integral to the microprocessor control module (2) or the aircraft's own communications system The communications module (3) wireless connection may be via means other than radio frequency The communications module (3) may also include a GPS (Global Positioning System) If a GPS system is included, the communications module (3) may be programmed to relay the positional data provided by the GPS system in its predetermined emergency signals

The microprocessor control module (2) is a small footprint computer/micro-microprocessor control module that controls the fingerprint scanning devices (7), smart card readers (1), and communications module (3) utilized in this invention. It contains resident programming that allows it to receive the live scan fingerprint images from the fingerprint scanning device (7) to extract the unique characteristics of the image, and to form a template for the image based on those characteristics. The programming also provides for receiving the information stored on the smart card from the smart card reader (1). This information includes the user's stored fingerprint template. The program then compares the template from the live scan image received from the fingerprint scanning device (7) to the stored template received form the smart card Based on this comparison, it then provides a signal to the communications module (3) as needed The microprocessor control module (2) could be any suitably powerful computing platform As currently proposed it does not provide for any exterior user input Other variations could include computers that allow for user input via external keyboards and/or integral keypads Attention should be given to the enclosure and placement of the microprocessor control module (2) to ensure that it is secure.

The invention contains four primary components, the fingerprint scanning device (7), the smart card reader (1), the communications module (3), and the microprocessor control module (2) The connections between these components are as follows: the fingerprint scanning device (7) (or devices as required by the particular installation) is/are connected to the microprocessor control module (2) via a hardwired connection (9). The smart card reader (1) (or Readers as required by the particular installation), is/are connected to the microprocessor control module (2) via a hardwired connection (9) The communications module (3) is connected to the microprocessor control module (2) via a hardwired connection (9). Depending on the installation and preference of the user, the communications module (3) may be connected via a hardwired communications (5) or a wireless connection (6) to an onboard communications device, such as a transponder, that can communicate with parties both inside and outside of the aircraft This wireless connection (6) could involve a radio frequency of predetermined wavelength, or similar signal Given that the system is always active, it is important that it allow for routine periods when there will not be a flight crew present and therefore no smart cards will be detected These periods could include crew changeovers at the gate, maintenance, etc The system will always assume that there is a problem if it does not detect a smart card present and will attempt to communicate as programmed To prevent this incorrect communication, the communications module (3) may be designed to only receive power when the aircraft is in use This may be accomplished by supplying power via an interlocked power connection (13) to the communications module (3) when systems that operate only when the aircraft is in use are engaged. These systems could include, but are not limited to, the aircraft's brakes or some other system as dictated by reliability and ease of connectivity Depending on the particular design and capabilities of the fingerprint scanning device (7) (or fingerprint scanning devices) and smart card reader (1), (or smart card readers), they may be connected to each other via a hardwired connection (9). In the event that the fingerprint scanning device (7) (or devices) and the smart card reader (1), (or Readers) are connected to each other, all of these individual components may or may not be connected to the microprocessor control module. There may be a smaller number of connections to the microprocessor control module than there are fingerprint scanning devices (7), and smart card readers (1) in use. The microprocessor control module (2) gains power for operation via a hardwired power connection (10) to an onboard power source. Depending on the installation and preference of the user, the communications module (3) may be connected via a hardwired (5) or wireless connection (6) to an onboard autopilot system

Possible variations in the connections of the components of this system include the following: the Fingerprint Scanning Device (7) (or devices as required by the particular installation) may be connected to the microprocessor control module (2) via a wireless connection (6). The smart card reader (1), (or readers as required by the particular installation), may be connected to the microprocessor control module (2) via a wireless connection (6) The communications module (3) may be connected to the microprocessor control module via a wireless connection (6) Depending on the installation and preference of the user, the communications module (3) may communicate directly via a wireless means with a party/or parties outside of the aircraft. This communication could involve a microwave, cellular telephone (analog or digital) or any other reliable mode of wireless connection. Depending on the installation and preference of the user, the communications module (3) may be connected via a wireless connection or hardwired connection to a visual or audible alert system in the crew areas of the passenger cabin. The microprocessor control module (2) gains power for operation via a hardwired power connection (10) to an onboard power source. The power connection to the microprocessor control module (2) may be designed such that it only receives power when another instrument and/or piece of equipment on the aircraft is operational In that case, the hardwired power connection (10) )between the microprocessor control module and the power supply may include various switches and relays as required by the specific installation Depending on the particular design and capabilities of the fingerprint scanning device (7), (or devices) and smart card reader (1), (or readers), they may be connected via a wireless connection (6)

The system envisioned for the best mode and its operation is as follows.

Authorized flight personnel are issued individual smart cards (not shown) that contain stored images of the authorized user's fingerprints, as well as other identity information which could include but is not limited to, their name, social security number and pilot's license number The smart card may also contain a security code or feature that is revised and refreshed on a routine basis to prevent unauthorized personnel from counterfeiting the cards. If so designed, the system will contain appropriate programming and interfaces to allow for updating the security codes resident in the onboard units. The smart card is inserted into the smart card bay (8) of the system described below when the member of the flight crew takes their position at the controls

System Description

The cockpit of the aircraft would contain one or more fingerprint scanning devices (7) which may be mounted in various locations, which will vary dependent on the aircraft control configuration and the preference of the user The primary mounting locations could include, but are not limited to, the control yoke (11), the control stick (4), and a free standing unit (12) which may be mounted in any preferred position on the flight deck (cockpit). A preferred position in this case being one that allows for ready access to the fingerprint scanning device (7) by the flight crew The fingerprint scanning device (7) is connected to the microprocessor control module (2) via a hardwire connection (9). The cockpit also contains a smart card reader (1) in a quantity which is equal to the number of Fingerprint Scanning Devices (7) present The smart card reader (1) is connected to the microprocessor control module (2) via a hardwire connection (9) The smart card reader (1) is mounted in such a way as to provide for easy insertion of the smart card by the individuals at the controls, as well fast and easy removal of the smart card should an emergency arise The cockpit also contains a communication module (3) which is connected to the microprocessor control module (2) via a hardwire connection (9). The communications module (3) may also be connected to other devices on board the aircraft via a hardwire communications (5) These devices could include communications devices such as, but not limited to, the aircraft's transponder, and/or alarm systems such as lights and/or audible alarms in the crew areas of the passenger cabin The communications module (3) may also be connected with communication and/or alarm systems on board, and outside of, the aircraft via a wireless communications connection (6). The communications module (3) may also be connected to the autopilot (or similar) system on board the aircraft via a hardwire communications (5), or wireless communications (6)

System Operation

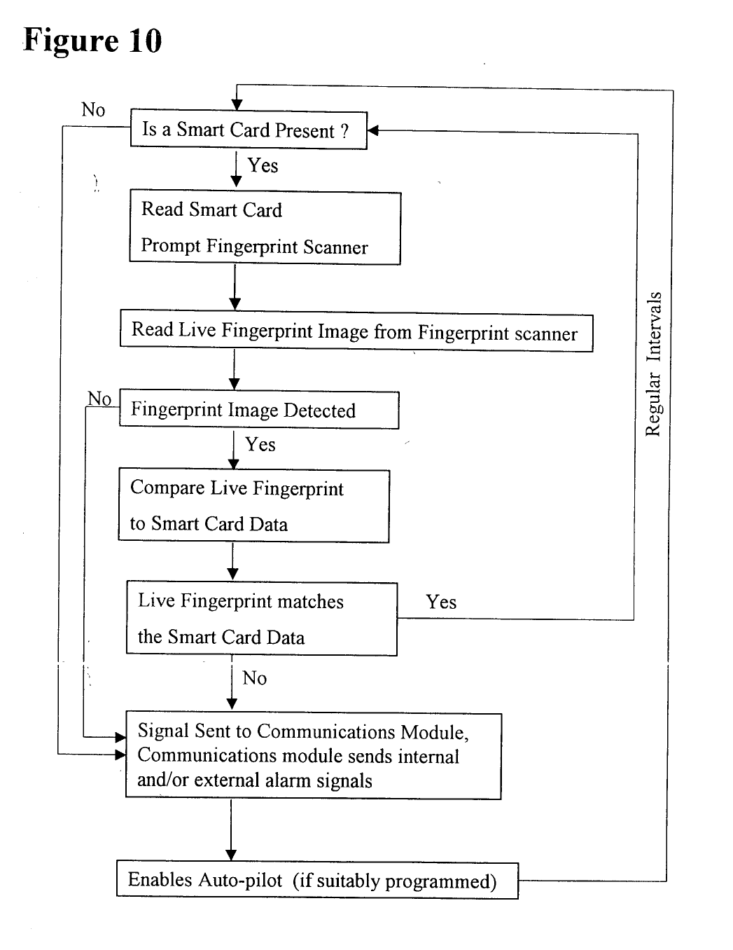

As illustrated by the flowchart in FIG. 10, upon entering the cockpit, each member of the flight crew inserts their smart card into the smart card bay (8) of the smart card readers (1) Upon recognizing that a smart card is present, the microprocessor control module (2) reads the data contained on the smart card including the stored fingerprint template and instructs the fingerprint scanning device (7) to prompt the individual at the controls to place their finger over the fingerprint scanning device (7) for identity authentication. The prompt may be visual (via flashing lights), and/or audible (via a tone). The individual places their finger on the fingerprint scanning device (7), and the fingerprint scanning device (7) creates a live scan image of the individual's fingerprint and relays it to the microprocessor control module (2) The microprocessor control module (2) then analyzes the live scan fingerprint image from the fingerprint scanning device (7), extracts unique characteristics, and creates a template of the image The microprocessor control module (2) then compares the template from the live scan fingerprint image to the template stored on the smart card If the templates match, identity is authenticated If the system is unable to authenticate the identity of at least one individual at the controls, the microprocessor control module (2) will send a signal to the communications module (3) The communications module (3) will in turn send a signal via a hardwire connection (5) or a wireless communications connection (6) to a communications system and/or alarm system on board and/or outside of the aircraft The signal from the communications module (3) may also be relayed to the onboard auto pilot instructing it to execute a preprogrammed safe flight pattern The fingerprint scanning device (7) continues to prompt the crew for fingerprint authentication at predetermined repetitive intervals during flight.

The Logic involved in the software is illustrated by the flowchart in FIG. 10 is as follows

Fingerprint Scanning Device (7) and Smart Card Reader (1) Operation

1 The microprocessor control module (2) continually checks for the presence of a smart card in the smart card reader (1)

2 IF a smart card is detected in the smart card reader (1), THEN the microprocessor control module (2) retrieves the information stored on the smart card, which contains information about the identity of the cardholder, including their stored fingerprint template. The microprocessor control module (2) then instructs the fingerprint scanning device (7) to prompt the user for fingerprint verification at predetermined intervals during flight The fingerprint scanning device (7) then prompts the user to verify their fingerprint. The fingerprint scanning device (7) scans the fingerprint that is placed on the scanning surface by the individual responding to the prompt, and creates a live image which is read by the microprocessor control module (2) The microprocessor control module (2) then extracts the unique characteristics of the live image from the fingerprint scanning device (7)), and generates a template from the live image for comparison The microprocessor control module (2) then compares the template from the live image to the stored template from the smart card that is in the smart card reader (1) The two templates are compared to each other to see if they match.

IF the two templates match, THEN no further action is taken by the microprocessor control module (2) until the predetermined interval expires, when the microprocessor control module (2) again prompts the fingerprint scanning device (7) for verification.

IF the two templates do not match THEN the microprocessor control module (2) sends a signal to the communications module (3) instructing the communications module (3) to send a preprogrammed signal or signals to parties outside and/or inside the aircraft

3. IF there is no smart card present, THEN the microprocessor control module (2) sends a signal to the communications module (3), instructing the communications module (3) to send a preprogrammed signal or signals to parties outside and/or inside the aircraft.

Communications Module (3) Operation

1 IF no smart card is detected OR the identity of the operator cannot be authenticated via matching a live image from the fingerprint scanning device (7) to the stored template on the smart card relayed by the smart card reader (1), THEN the communications module(3) sends a predetermined signal or signals to parties outside and/or inside the aircraft If so programmed, the communications module (3) would also send a signal to the onboard autopilot system causing it to initiate a preprogrammed safe flight pattern.

2. if smart card is present or the identity of the operator is authenticated, then the communications module (3) does not transmit a signal

It should be noted that the software is written such that simultaneous authentication of both identities is not required. A single confirmation at each interval is sufficient. This allows for a member of the crew to leave the flight deck as necessary. If a smart card is removed, the microprocessor control module (2) will immediately signal the communications module (3) to send the predetermined emergency signals. This feature allows the smart card reader (1) to function as a “Panic Button” In the event that there is a breach of security on the aircraft, the flight crew merely has to remove one or more of the smart cards. The microprocessor control module (2) will then initiate the emergency communication as discussed above

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention

What is claimed is

1 For use with an aircraft, a biometric in-flight aircraft flight crew authentication device comprising,
at least one scanning device mounted on board the aircraft to capture a live image of a physiological identification data of a flight crew member capable of transmitting said live image data via an image signal;
having a flight crew member's preprogrammed physiological identification data on a stored data means,
at least one reading means for reading the preprogrammed physiological identification data and transmitting said preprogrammed physiological identification data from the stored data means,
a microprocessor control module for receiving said preprogrammed physiological identification data and comparing with said live image data image signal before an aircraft flight and transmitting a comparison result,
a communications module for receiving the comparison result from the microprocessor control module giving a positive signal when said physiological identification signal correctly matches said preprogrammed physiological identification data with said live physiological data image and giving a negative signal when said physiological identification signal incorrectly matches said preprogrammed physiological identification data;
a responsive means to said negative signal of the comparison result of the microprocessor control module for transmitting an output signal on board the aircraft or/and outside the aircraft

2 A biometric in-flight aircraft flight crew authentication device as claimed in claim 1 wherein said preprogrammed physiological data is a fingerprint image

3 A biometric in-flight aircraft crew authentication device as claimed in claim 1 having a hard wired communication means.

4 A biometric in-flight aircraft crew authentication device as in claim 1 wherein said communication means being either inside or outside of the aircraft such as air traffic control, crew area, or an onboard auto pilot system.

5 A biometric in-flight aircraft crew authentication device as claimed in claim 1 having a wireless communication means.

6 A biometric in-flight aircraft crew authentication device as claimed in claim 1 wherein the outside party or parties take in-flight corrective action such as control of an autopilot system.

7 A biometric in-flight aircraft crew authentication device as claimed in claim 1 having means for communication to an onboard preprogrammed autopilot system allowing the autopilot system to disable manual controls of the aircraft and initiate a safe flight pattern

8 A biometric in-flight aircraft flight crew authentication device as claimed in claim 1 which repetitively compares the preprogrammed physiological identification data with the live image data of those at the controls of the aircraft or in the crew area at predetermined intervals during flight.

9 A biometric in-flight aircraft flight crew authentication device as claimed in claim 1 that after detection of a negative signal from the comparison result, initiates a predetermined sequence of actions intended to ensure the safety of the aircraft in question and the aircrafts occupants

10 A biometric in-flight aircraft flight crew authentication device as claimed in claim 1 that upon detection of a negative signal from the comparison result, communicates with an appropriate party or parties outside and/or inside of the aircraft and notifies them of an unauthenticated individual at the controls by means of an audible or sensory alarm.

11 A biometric in-flight aircraft flight crew authentication device as claimed in claim 1 that upon subsequent repetitive comparison receives a positive signal from the comparison result, the device then sends a signal to the autopilot system to return control of the aircraft to the manual controls.

12 For use with an aircraft, a system for a biometric in-flight aircraft flight crew authentication system comprising:
means for scanning on board an aircraft a live physiological identification image of a flight crew member,
memory means for storing preprogrammed physiological identification data representative of an authorized flight crew member;
means for reading a flight crew member's pre-selected physiological identification data and transmitting data to a microprocessor control module;
said microprocessor control module receiving the live physiological identification image for comparison with the stored physiological identification data on the storing means,
means responsive to said comparison

13 A biometric in-flight aircraft flight crew authentication system as claimed in claim 12 wherein said physiological stored data is a fingerprint image.

14 A biometric in-flight aircraft crew authentication system as claimed in claim 12 wherein the communication means is hard wired.

15 A biometric in-flight aircraft crew authentication system as in claim 12 wherein said communication means being either inside or outside of the aircraft such as air traffic control, crew area, or an onboard auto pilot system

16 A biometric in-flight aircraft crew authentication system as claimed in claim 12 wherein the communication means is wireless

17 A biometric in-flight aircraft crew authentication system as claimed in claim 12 wherein the outside party or parties take in-flight corrective action such as control of an autopilot system

18 A biometric in-flight aircraft crew authentication system as claimed in claim 12 including means for communication to an onboard preprogrammed autopilot system allowing the autopilot system to disable manual controls of the aircraft and initiate a safe flight pattern

19 A biometric in-flight aircraft flight crew authentication system as claimed in claim 12 including means for repetitively comparing the live physiological identification image of a flight crew member at the controls of the aircraft or in the crew area and the stored preprogrammed physiological identification data at predetermined intervals during flight.

20 A biometric in-flight aircraft flight crew authentication system as claimed in claim 12 that communicates with an appropriate party or parties outside and/or inside of the aircraft and notifies them of a negative response to said comparison by means of an audible or sensory alarm.

21 A biometric in-flight aircraft flight crew authentication system as claimed in claim 12 that returns control of the aircraft to the manual controls after a positive response to the comparison is received.
